(19) United States
(12) Patent Application Publication
(10) Pub. No.: US 2018/0186085 A1
(43) Pub. Date: Jul. 5, 2018

(54) METHOD FOR MANUFACTURING PLASTIC PEDELEC FRAMES, AND ACCORDINGLY MANUFACTURED PEDELEC FRAME

(71) Applicant: REHAU AG + CO, Rehau (DE)

(72) Inventors: Alexander Oelschlegel, Konradsreuth (DE); Martin Sonntag, Hof (DE); Daniel Rinesch, Hof (DE)

(21) Appl. No.: 15/315,598

(22) PCT Filed: May 26, 2015
(86) PCT No.: PCT/EP15/01075

§ 371 Date: Dec. 1, 2016

(30) Foreign Application Priority Data
Jun. 4, 2014 (DE) 102014107852.7

(51) Int. Cl. B29C 65/16; B62K 19/16; B29C 65/00

(52) U.S. Cl. CPC B29C 65/1638; B62K 19/16; B62M 6/55; B29C 66/547; B29C 66/124

(57) ABSTRACT

The invention relates to a method for manufacturing a plastic pedelec frame (1) by, preferably integrally, joining two matching plastic half-shells (2, 3), said pedelec frame being provided with receptacles (12, 13, 14) for a handlebar (4), a bottom bracket (5) and preferably a seat (6). The two plastic half shells (2, 3) are made from a fiber-reinforced thermoplastic material containing a partially aromatic polyamide, using an injection molding process. The invention also relates to a pedelec frame (1) manufactured by said method.

The present invention relates to a method for the production of a pedelec frame, in which two plastic half-shells are joined together and are preferably connected to one another by material bonding. Pedelecs differ from a normal bicycle through an additional electric motor, a battery element for the motor drive, and usually control electronics for the motor. In practice, pedelec frames are often made of aluminum.

In the case of pedelecs when compared with normal bicycles, the special feature is that they must be equipped with an electric motor and at least one battery element. The electric motor may be connected to the pedal drive by the cyclist. Moreover, pedelecs often contain control electronics that measure the force or speed that is applied and actuate or deactivate the motor when certain values are reached. The additional elements of a pedelec require that the frame tubes must be manufactured with a comparatively large diameter in order to accommodate the supply elements therein. To a certain extent, these may also be attached externally to the frame, but this is not very appealing aesthetically.

In addition, pedelec frames are much heavier than normal bicycle frames due to the additional elements. There are approaches to producing pedelec frames from two half-shells, in which the supply elements are stowed. This is disclosed, inter alia, in the documents DE 10 2011 053 100 A1 and DE 20 2013 002 987 U1. From the latter document, a pedelec frame is disclosed which is manufactured from two half-shells. However, in the case of commonly-used plastics, in many cases the necessary load-bearing capacity of the material necessary for a pedelec is lacking because of the additional weight of the drive elements.

The object of the invention is to provide a method for producing a plastic pedelec frame which ensures high load-bearing capacity of the pedelec frame and which may be easily automated.

The object is achieved according to the invention by a method for producing a pedelec frame made of plastic,
wherein this is produced by combining two corresponding plastic half-shells,
wherein the pedelec frame has receptacles for a handlebar, for a bottom bracket and preferably for a cyclist's saddle, and
wherein the two plastic half-shells are produced by means of an injection-molding process from a fiber-reinforced thermoplastic synthetic material which contains a partially aromatic polyamide.

In this case, the half-shells are preferably essentially mirror-image-shaped. As a result of their joining, an inner cavity is formed between the half-shells, which may serve to accommodate at least one pedelec component. The pedelec component accommodated by the cavity may, for example, be an energy storage device, preferably a battery, and/or an electric motor of the pedelec. Expediently, defined positioning is produced by combining the plastic half-shells for the energy storage device and/or the electric motor and/or the bottom bracket in the inner cavity. In addition to the mountings for the handlebars, the bottom bracket and the cyclist's saddle, the pedelec frame may also comprise an integral rear structure to support the rear-wheel. As an alternative to this, however, it is also possible that a separate rear structure is attached to the pedelec frame to support the rear wheel. This rear structure may be provided with a suspension. The inner sides of the half-shells advantageously contain positioning elements for the energy storage device, preferably a battery, as well as for an electric motor. These positioning elements are expediently integrally formed on one of the two, or also on both, half-shells. In the receptacles of the pedelec frame, corresponding receiving sleeves may be provided for the handlebars, the bottom bracket or the cyclist's saddle, in order to create a seam-free stable receiving device.

The method according to the invention has the advantage that, owing to the use of a partially aromatic polyamide, it is possible to produce light and high-quality pedelec frames offering particularly high stiffness and, moreover, offering high stability under temperature loading. The material used according to the invention offers good weldability, so that, if necessary, known bonding methods may be dispensed with, and thus time-consuming curing of the adhesive is avoided. It goes without saying that it is also within the scope of the invention to join the plastic half-shells by means of an adhesive. The method according to the invention makes it possible to produce a complete pedelec frame from a plastic and thus to dispense with heavy metal components.

A further advantage of the material used is its significant flowability; it is possible to injection-mold ribs and/or connecting and/or functional elements on the half-shells during the injection molding process, preferably on the inner side of the respective half-shell. These may be used as receptacles for other pedelec components such as forks, bottom brackets, saddles or handlebars.

According to the invention, the two half-shells are produced from a fiber-reinforced thermoplastic, which contains a partially aromatic polyamide. Compared to conventional polyamides, partially aromatic polyamides offer improved thermal properties and very good dimensional stability. The partially aromatic polyamide of the present invention is conveniently selected from one containing aliphatic dicarbonyl repeat units and aromatic diamino repeat units, or from one containing aromatic dicarbonyl repeat units and aliphatic diamino repeat units, or from a mixture of the aforementioned substances. Preferably, the partially aromatic polyamide contains meta-xylylenediamine repeat units and 1,6-hexanedionyl repeat units. The combination of these components is particularly suitable because of the high stiffness, the low water absorption and the high resistance to moisture and heat.

In order to further optimize the material properties, an aliphatic polyamide may also be admixed in the fiber-reinforced thermoplastic in addition to the partially aromatic polyamide. This also offers a cost saving. According to the invention, the weight fraction of the partially aromatic polyamide is at least 50%, preferably at least 70%, based on the total plastic mass without fiber reinforcement.

The weight fraction of the fiber reinforcement in the plastic is 15-70%, preferably 40-60%. Surprisingly, this highly-filled and therefore highly-loadable plastic is, for example, very well suited for laser welding. With a weight fraction of the fibers below 15%, the partially aromatic polyamide has insufficient strength. With a weight fraction of more than 70%, the material has reduced moldability. In addition, a polyamide with such a fiber volume is too rigid and brittle for use in a pedelec frame.

Carbon, aramid or glass fibers are suitable for fiber reinforcement. Preferably only glass fibers are used. Compared to carbon fibers or aramid fibers, these are much more cost-effective and still offer good reinforcement with very high thermal and chemical stability.

Short fibers with an average length of less than 15 mm, preferably 10 mm, e.g. less than 5 mm, are suitable in particular. Even shorter average fiber lengths of less than 3 mm, e.g. less than 2 mm or less than 1 mm, are also suitable. Short fibers may be processed without difficulty in the plastic matrix by injection molding. Injection molding permits an extremely wide variety of shapes and, in particular, is also suitable for forming the above-described positioning elements for the positioning of the electric motor and energy storage device via a corresponding shaping of the injection molds onto the half shell(s) in a simple manner. Short fibers are also much more cost-effective than long fibers.

Expediently, the geometry of the half-shells at their joining edges is such that the edge of the one half-shell has a groove while the edge of the other half-shell has a spring engaging in the groove. The spring and groove are preferably so dimensioned that a clamping connection is produced when the half-shells are assembled. For this purpose, either the spring is slightly oversized or the groove is slightly undersized. As a result, the two half-shells are initially pre-fixed against one another prior to the welding process. This makes it possible to control the correct joining of the half-shells before the, for example irreversible, material-bonding joining process (gluing, welding, etc.). If necessary, the spring-and-groove connection may be loosened once again before the material bond is produced. In particular, it is possible in this way to control the correct positioning of the electric motor and energy storage device in the cavity formed by the two half-shells before, for example, the welding process is carried out, or the adhesive is cured.

Subsequently, the assembled half-shells are preferably connected to one another by material bonding. For this purpose, they are welded, for example, to the pedelec frame by means of laser radiation, preferably circumferentially. A diode laser with a wavelength of 500 nm to 1100 nm, for example a solid-state diode laser with a wavelength of 1064, is preferably used to generate the laser radiation. One of the joining partners, which is laser-transparent, is irradiated by the laser and the energy is absorbed by the second, laser-absorbing joining partner on its surface. The plastic melts at this surface, so that the two joining partners may thereby be bonded together in a material-bonding manner. For this purpose, it is necessary that one of the half-shells has a high degree of transmission in the region of the laser wavelength, while the other half shell has a high degree of absorption at this wavelength. The laser absorption may be achieved, for example, by adding laser-absorbing pigments, preferably carbon black, to the plastic of the one half-shell. Advantageously, the half-shell, the edge of which forms the groove, is laser-transparent, while the half-shell, the edge of which forms a spring, is laser-absorbing.

In a further embodiment, a diode laser with a wavelength of 1300-2200 nm, preferably 1400 nm-2000 nm, is used. In the region of these wavelengths, the macromolecules of the plastic may be excited directly by the laser radiation to cause them to reach the required welding temperature. Therefore, pigmentation of the plastic is no longer necessary at these wavelengths. Preferably, the laser has a diode emitter with thulium and/or erbium. The melting zone is determined in this welding process by focusing the laser beam in the desired range.

Irrespective of the laser method used, at least one of the two half-shells may be produced from a plastic which is transparent to the human eye, so that after the welding process, optical inspection of the weld seam is possible. This is preferably the groove-forming half-shell.

In order to make the pedelec frame aesthetically pleasing, as a rule an opaque lacquer coating of the half-shells joined to the pedelec frame is carried out. This also eliminates the possibly different optics of the two half-shells, which may result, in particular, from the previously described different pigmentation of the two half-shells in the case of the laser transmission method. As already explained, the two half-shells may, in principle, also be connected to one another by means of a different joining process, for example by means of a conventional adhesive method.

In the plastic half-shells, recesses may be milled into the plastic half-shells, which are used to hold pedelec components, in particular an electric motor and/or battery element and/or bottom bracket. With the help of this post-processing step, the geometry may be adapted very flexibly to the specific requirements. Thus, for example, undercuts may be made here, which cannot be produced by an injection molding process alone or only with great effort (additional slide etc.). It has been found within the scope of the invention that the polyamide which is used is not only highly suitable for injection molding but also for milling.

The object of the invention is also a pedelec frame produced according to one of the preceding methods.

### BRIEF DESCRIPTION OF THE DRAWINGS

In the following, only exemplary embodiments of the invention are explained in more detail with reference to the drawings. These are as follows:

FIG. 1 shows a pedelec frame produced according to the invention in a three-dimensional representation;

FIG. 2 shows the cross-section A-A in FIG. 1 during the joining process;

FIG. 3 shows a further embodiment of the invention in a representation corresponding to FIG. 2;

FIG. 4 shows an enlarged detail of FIG. 2 in a three-dimensional representation, and

FIG. 5 shows an enlarged detail of FIG. 3 in a three-dimensional representation.

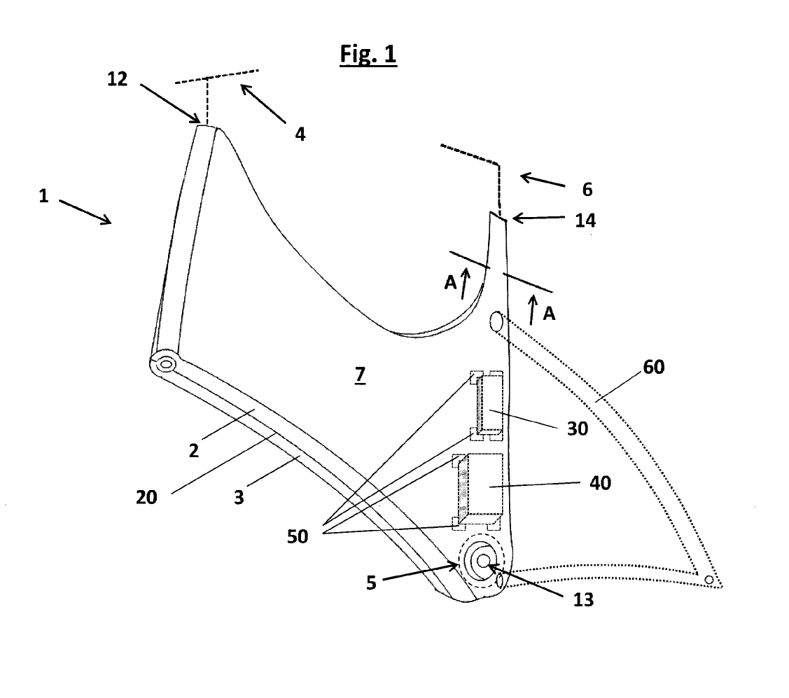

FIG. 1 shows a pedelec frame 1 according to the invention, which is produced by the assembly of two corresponding plastic half-shells 2, 3. The pedelec frame 1 has a receptacle 12 for handlebars 4, a receptacle 13 for a bottom bracket 5 and a receptacle 14 for a cyclist's saddle 6. The handlebars 4, bottom brackets 5 and cyclist saddles 6 are merely indicated in FIG. 1. A rear-mounted, optionally suspension-mounted, rear axle 60, which is shown in dashed lines, is fastened on the pedelec frame, and serves to support the rear wheel (not shown) of the pedelec. The two half-shells 2, 3 consist of a fiber-reinforced thermoplastic, which contains a partially aromatic polyamide. By joining the two half-shells 2, 3, an inner cavity 7 is formed, which accommodates a battery 30, an electric motor 40, and the bottom bracket 5 of the pedelec. Upon joining the plastic half-shells 2, 3, the battery 30, the electric motor 40 and the bottom bracket 5 are also positioned at defined locations in the inner cavity 7. The plastic half-shells 2, 3 produced by means of an injection-molding process comprise positioning elements 50 integrally formed, to hold the electric motor 40, the battery 30 and the bottom bracket 5 in the desired position.

The partially aromatic polyamide of the half-shells consists, in the exemplary embodiment, of meta-xylyenediamine 6, which is formed from meta-xylyenediamine and adipic acid. The structural formula of this material is:

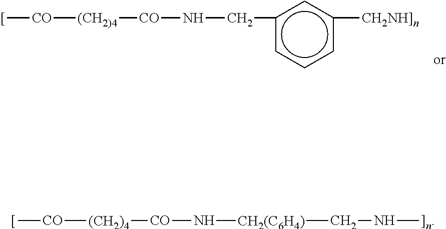

In addition, ribs and/or connecting elements and/or functional elements are injection-molded onto the half-shells 2, 3 during the injection molding process. These are used, for example, as mountings for other pedelec components such as forks, bottom brackets, saddles or handlebars. The weight fraction of the partially aromatic polyamide, based on the total plastic mass without fiber reinforcement, is 90% in the exemplary embodiment.

The fiber reinforcement of the thermoplastic consists comprises pure glass fibers finely distributed in the plastic matrix of this polyamide. The average fiber length is less than 1 mm. The weight fraction of the fibers in the fiber-reinforced thermoplastic is 50% in the exemplary embodiment. After joining, the two half-shells 2, 3 are connected together by material bonding and subsequently painted in opaque form.

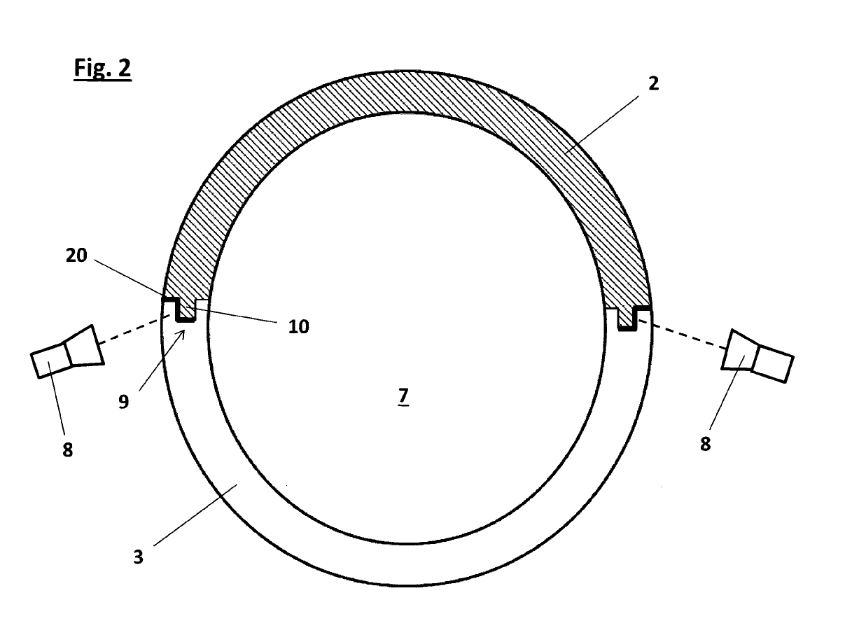

The cross-sectional representation in FIG. 2 shows the section A-A through the plastic half-shells 2, 3 in FIG. 1. The plastic of the half-shell 3, which forms a groove 9, is provided for the joining process of the two half-shells 2, 3 through a laser 8 and is transparent to this laser 8. The other half-shell 2, on the other hand, is made of a material that absorbs the laser 8 used. To achieve the laser absorption, carbon black (indicated by hatching) is added to the plastic of this half shell 2. In a preferred embodiment, the laser beam welding method is used for connecting the two half-shells, wherein a diode laser 8 having, for example, a wavelength of 1064 nm is used to generate the laser beam. The laser beam passes through one laser-transparent half-shell 3 and the energy of the laser is absorbed by the second laser-absorbing half-shell 2 on its surface. The plastic melts there, so that a material bonding of the two half-shells 2, 3 forms the weld 20. The half-shell 3 also consists of a plastic material that is transparent to the human eye so that the weld 20 may be optically controlled.

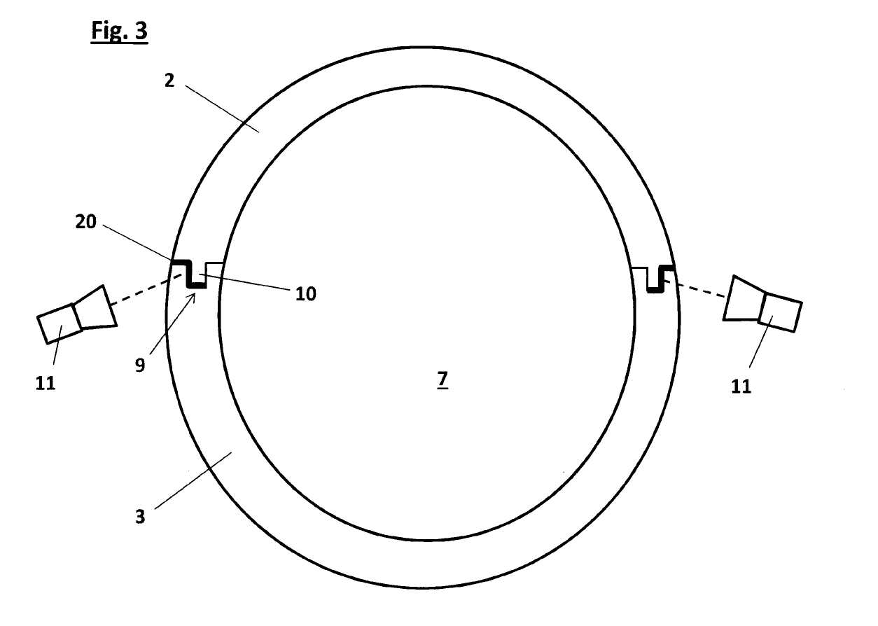

FIG. 3 shows an alternative welding process. In this case, a diode laser 11 with a wavelength of 1400 nm to 2000 nm is used. By focusing the laser beam onto the desired melting zone 20, the macromolecules of the plastic may be directly excited without the need for absorbers. Again, the half-shell 3 is made of a plastic material transparent to the human eye. Within the scope of the invention, however, it is also generally possible to bond the two half-shells together by means of an adhesive.

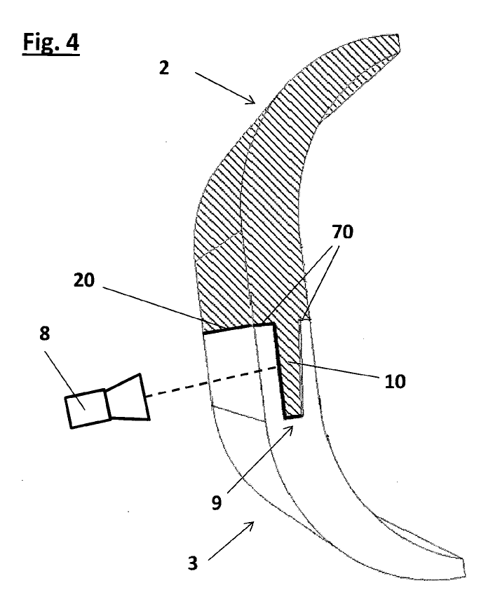

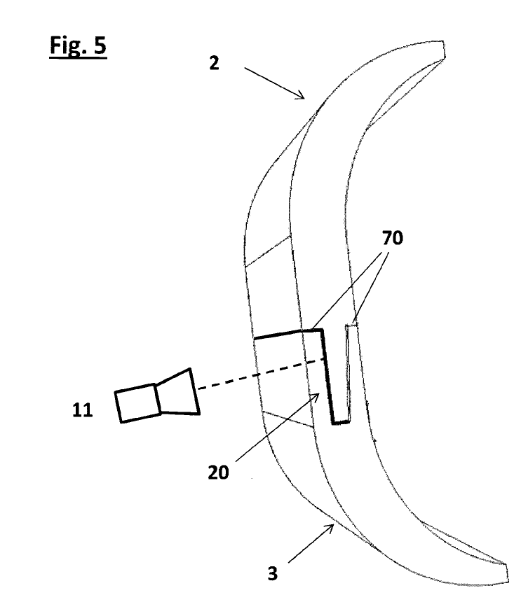

FIGS. 4 and 5 respectively show an enlarged section of the joining connection of the two half-shells 2, 3. The geometry of the spring-and-groove connection is such that a clamping connection is already produced by the insertion of the spring 10 into the groove 9 of the half shells 2, 3 before the laser welding. For this purpose, the spring 10 is slight oversized with respect to the groove 9.

1.-15. (canceled)

16. A method for producing a pedelec frame made of plastic, comprising:
bringing two corresponding plastic half-shells into engagement with one another;
wherein the pedelec frame includes recesses for a handlebar, a bottom bracket and a cyclist's saddle; and
wherein the two plastic half-shells are produced by an injection molding process from a fiber-reinforced thermoplastic synthetic material that contains a partially aromatic polyamide.

17. The method according to claim 16, wherein the partially aromatic polyamide is selected from the group consisting of aliphatic dicarbonyl repeat units, aromatic diamino repeat units, aromatic dicarbonyl repeat units, aliphatic diamino repeat units and combinations thereof.

18. The method according to claim 16, wherein the partially aromatic polyamide comprises meta-xylylenediamine repeat units and 1,6-hexanedionyl repeat units.

19. The method according to claim 16, wherein the fiber-reinforced thermoplastic synthetic material further comprises an aliphatic polyamide.

20. The method according to claim 16, wherein a weight fraction of the partially aromatic polyamide is in the range of at least 50% to at least 70% based on a total mass of the thermoplastic synthetic material without the fiber reinforcement.

21. The method according to claim 16, wherein the fiber reinforcement is selected from the group consisting of glass fibers, carbon fibers, aramide fibers and combinations thereof.

22. The method according to claim 16, wherein a weight fraction of the fibers in the fiber-reinforced thermoplastic synthetic material is in the range of 15-70%.

23. The method according to claim 16, wherein an average length of the fibers in the pedelec frame is less than 15 mm.

24. The method according to claim 16, wherein one of the plastic half-shells, at a joining edge thereof, includes a groove formed thereon, while a joining edge of the other plastic half shell includes a spring that engages the groove during engagement of the plastic half-shells.

25. The method according to claim 24, wherein the spring and groove connection is such that a clamping connection is produced by the joining of the spring in the groove, which pre-fixes the plastic half-shells to one another.

26. The method according to claim 16, wherein the two plastic half-shells are bonded to one another through welding at corresponding joining edges thereof, and to the pedelec frame by means of laser radiation, thereby forming an inner cavity operable to accommodate an energy storage device and an electric motor therein.

27. The method according to claim 26, wherein one of the plastic half-shells is made of a laser-absorbing plastic material, while the other plastic half-shell is made of a laser-transparent plastic material.

28. The method according to claim 27, wherein a joining edge of one of the plastic half-shells includes a groove formed of the laser-transparent plastic, while a joining edge of the other plastic half-shell includes a spring formed of the laser-absorbing plastic.

29. The method according to claim 6, wherein recesses are milled into the plastic half-shells prior to their engagement with one another, wherein the recesses are configured to hold pedelec components, an electric motor, a battery element or a bottom bracket.

30. A pedelec frame produced by a method according to claim 16.
